(19) United States
(12) Patent Application Publication
(10) Pub. No.: US 2025/0063462 A1
(43) Pub. Date: Feb. 20, 2025

(54) COMPUTER NETWORK FOR LOCATION AND DATA TRANSFER

(71) Applicant: GEOMOBY PTY LTD, Scarborough (AU)

(72) Inventor: Christophe Baudia, Scarborough (AU)

(21) Appl. No.: 18/720,491

(22) PCT Filed: Dec. 16, 2022
(86) PCT No.: PCT/AU2022/051530

§ 371 Date: Jun. 14, 2024

(30) Foreign Application Priority Data
Dec. 16, 2021 (AU) 2021904093

(51) Int. Cl. H04W 40/22; H04B 1/40; H04L 67/06; H04W 88/16

(52) U.S. Cl. CPC H04W 40/22; H04B 1/40; H04L 67/06; H04W 88/16

(57) ABSTRACT

A local area network comprises a plurality of relay nodes. Each relay node comprises a first transceiver for communicating with one or more other relay nodes; a second transceiver for communicating with one or more mobile devices; a bridge for transferring data between the first and second transceivers. At least one of the relay nodes is configured to form a connection to an upstream server via a gateway to another area network. At least one of the relay nodes is configured to form a connection to the upstream server via the respective first transceiver of one other relay node, such that a single path along a chain of connections is established upstream. Each relay node is configured to transfer the data to the upstream server via the chain of connections.

### FIELD OF THE INVENTION

The present invention relates to computer networks usable to provide location of devices in a network area and for transmission of data, including location related data across the network.

### BACKGROUND

Location of devices using networks, such as Bluetooth beacons, is known. However, these networks require relatively good signal reception and a suitable layout to track when a beacon device enters the coverage area of each beacon receiver. A single beacon signal receiving node generally can only determine an approximate range of the beacon from the receiver device by signal strength, whereas generally a plurality of beacons of known location are required by use of range and triangulation or multilateralation to determine a location (such as in a coordinate plane, or otherwise). In a large area, with long but not necessarily straight passages, a large number of beacons need to be employed and these are subject to failure if one of the nodes in a network fails or if a signal is blocked.

In an underground mining environment, signal may be blocked or significantly attenuated by rock, or mining equipment moving through the mine tunnel. This means that traditional beacons are not well suited for using in many mines.

Beacon networks while being useful for location detection are not able to be used to transfer other types of data, such as images or video files.

It is highly desirable to track the location of assets (people and machinery) and to share/send data files in environments such as an underground mine for productivity efficiency and safety reasons.

The present invention has been developed with this background in mind.

Any reference to prior art documents is not an admission that they form part of the common general knowledge of a skilled person in any jurisdiction.

### SUMMARY OF THE INVENTION

In this specification the terms “comprising” or “comprises” are used inclusively and not exclusively or exhaustively.

According to an aspect of the present invention there is provided a local area network comprising a plurality of relay nodes, each relay node comprising:
a first transceiver for communicating with one or more other relay nodes;
a second transceiver for communicating with one or more mobile devices;
a bridge for transferring data between the first and second transceivers;
wherein at least one of the relay nodes is configured to form a connection to an upstream server via a gateway to another area network;
wherein at least one of the relay nodes is configured to form a connection to the upstream server via the respective first transceiver of one other relay node, such that a single path along a chain of connections is established upstream;
wherein each relay node is configured to transfer the data to the upstream server via the chain of connections.

In an embodiment each relay node is configured to determining location information based on a signal transmitted between the or each mobile device and the second transceiver. In an embodiment each relay node comprises a processor for determining location information based on a signal transmitted between the or each mobile device and the second transceiver. In an embodiment the data transferred comprises the location information.

In an embodiment the first transceiver and the second transceiver are implemented as logical/virtual independent transceivers by a single physical transceiver.

In an embodiment the mobile device transmits at a lower power than the first transceiver transmits. In an embodiment the second transceiver transmits at a lower power than the first transceiver transmits.

In an embodiment each relay node in communication with one of the mobile devices is configured to transfer data from the respective device to the upstream server via the chain of connections.

In an embodiment the data from the respective mobile device and the location information is transmitted via the chain of connections.

In an embodiment the first transceiver of each of the relay nodes is able to connect to at least one other first transceiver of another relay node downstream. In an embodiment the first transceiver connects to a downstream other one of the relay nodes for connection of the downstream relay node to the upstream server.

In an embodiment each relay node is configured to receive a message/data from the upstream server. In an embodiment when the message/data is for a destination that is another one of the relay nodes or mobile device connected to one of the other relay nodes the message/data is sent to the relay node that is, or is connected to, the destination through the chain of connection established from the destination relay node or the relay node connected to the destination mobile device.

In an embodiment each relay node comprises a storage for buffering a file comprising the data and/or location information prior to transmission by the first transceiver to the upstream server. In an embodiment the file is stored until acknowledgement is receive from the upstream node that it has received the entire file.

According to an aspect of the present invention there is provided a local area network comprising a plurality of relay nodes, each relay node comprising:
a transceiver for communicating with one or more other relay nodes, and for communicating with one or more mobile devices;
wherein at least one of the relay nodes is configured to form a connection to an upstream server via a gateway to another area network;
wherein at least one of the relay nodes is configured to form a connection to the upstream server via the respective transceiver of one other relay node, such that a single path along a chain of connections is established upstream;
wherein each relay node is configured to transfer data from one or more of the mobile devices to the upstream server via the chain of connections.

In an embodiment the relay node comprises a processor for determining location information based on a signal transmitted between the or each mobile device and the transceiver. In an embodiment the data transferred from the mobile device comprises the location information. In an embodiment the data transferred from the mobile device comprises a data file.

In an embodiment the relay node stores the data file until it is received by the next node up in the chain of connections. In an embodiment the relay node comprises a file system for storing a plurality of data files.

In an embodiment the transceiver of each relay mode is configured to operate as a Peripheral when communicating across a connection to a downstream relay node. In an embodiment the transceiver of each relay node is configured to operate as a Central when communicating across a connection to an upstream relay node.

According to an aspect of the present invention there is provided a data network comprising a gateway for connection to an external network and a plurality of spatially separated relay nodes capable of wirelessly communicating with at least two other relay nodes, the gateway and a mobile device; wherein the gateway is configured to connect to one or more downstream relay nodes; each relay node is configured to connect to only one upstream device comprising either: the gateway or another relay node; each relay node is configured to connect to one or more downstream relay nodes and/or one or more downstream mobile devices; wherein relay nodes are configured to establish a single path of a chain of connections upstream to the gateway, such that data is transmitted between the gateway and each mobile device only through relay nodes along the single path that connects the gateway to the mobile device while said chain of connections between the gateway and the mobile device is in place.

In an embodiment each relay node is configured such that the connection is in place while a data connection requirement between relay nodes is met. In an embodiment the data connection requirement is met when a heartbeat or advertisement signal is received within a timeframe. In an embodiment the data connection requirement is met when the signal strength to the next upstream relay node is the strongest signal strength of possible connections via relay nodes that are equidistant by hops to the gateway. In an embodiment when another relay node of equal or fewer hops to the gateway has a stronger signal strength, the data connection requirement is no longer met and the relay node is configured to connect to the relay node of stronger signal strength so as to reform a new single path along a new chain of connections upstream to the server. In an embodiment the data connection requirement is no longer met when a reconnect command is received from a server. In an embodiment the reconnect command comprises a relay node identifier to which the relay node that received the reconnect command is to connect to so as to re-establish the chain of connections.

In an embodiment each relay node is configured such that in the event that one or more of the connections between relay nodes does not meet the data connection requirement then each connection between nodes that does not meet the data connection requirement is severed and then sequentially, each relay node that severed the connection seeks to make a chain of connections sequentially back to the gateway.

In an embodiment the heartbeat/advertisement signal comprises a battery level of the relay node and a signal strength of the next upstream node and any downstream nodes.

In an embodiment each relay node is configured such that the establishment of a connection seeks to have the least number of hops from the gateway to the unconnected relay node via other relay nodes.

In an embodiment the relay nodes are configured to connect a path from the gateway to each mobile device by the shortest path by number of hops between relay nodes where the connection between relay nodes meets the data connection requirement.

In an embodiment each relay node comprises a storage for storing a received data file until the file is successfully transmitted to the either the server or the next upstream relay node, or to the gateway (in the upstream direction) or the next downstream relay node or to each mobile device connected to the relay node (in the downstream direction).

In an embodiment each connection is a data tunnel between relay nodes or between one of the mobile devices and one of the relay nodes.

In an embodiment each relay node acts as a central to a downstream mode and acts as a peripheral to an upstream node.

According to an aspect of the present invention there is provided a network comprising: a gateway node connectable to another network and connectable to one or more relay nodes; each relay node connectable to one or more network enabled devices, only one relay node upstream to the gateway node and one or more other ones of the relay nodes downstream from the gateway node;
each relay node being configured to connect to the gateway node via the least number of other relay nodes;
each relay node being configured upon being disconnected from a path to the gateway node to attempt to connect to one of the other relay nodes to re-establish a connection to i) the gateway node, or ii) via a chain of connections to a relay node connected to the gateway node.

In an embodiment each relay node is configured to buffer a transmitted data file such that in the case of a connection to the gateway or the chain of connections is broken the data file is able to be later transmitted once the connection to the gateway or chain of connections is re-established.

According to an aspect of the present invention there is provided a network device comprising:
a first transceiver for communicating with one or more relay nodes;
a second transceiver for communicating with one or more mobile devices;
a bridge for transferring data between the first and second transceivers;
wherein the first transceiver is configured to form a connection to an upstream server via a gateway to another area network;
wherein the network device is configured to form a connection to an upstream server via either a respective first transceiver of one other relay node or the gateway;
wherein the network device is configured to transfer data to the upstream server via the connection.

In an embodiment the network device configured to determining location information based on a signal transmitted between the or each mobile device and the second transceiver. In an embodiment each relay node comprises a processor for determining location information based on a signal transmitted between the or each mobile device and the second transceiver. In an embodiment the data transferred comprises the location information.

According to an aspect of the present invention there is provided a location determining system comprising
a server;
a gateway device for connection to the server;
a connection based network of spaced apart point relay nodes at known locations, each relay node able to obtain a measurement being an estimate of a location of a mobile device relative to itself and to send the measurement via the gateway to the server;
the server stores valid locations or areas of the mobile device within a defined environment;
the server is configured to receive measurements and determine an estimated location over time of the or each mobile device based on one or more measurements related to the or each mobile device, the stored valid locations/areas and locations of each of the relay nodes.

In an embodiment the server determines the estimated location using a particle filtering algorithm. In an embodiment the probability of a particle location being the location of the mobile device is weighted according to the signal strength of the signal from the mobile device. In an embodiment when multiple relay nodes receive a signal from the mobile device the server weights the likelihood of the location information being correct according to the signal strength received by the respective relay node. In an embodiment the server stores line of sight areas of each relay node and when determining an estimated location discards possible locations from relay nodes that are not in the stored line of sight ear of the respective relay node. In an embodiment possible locations that are inconsistent with the topology of the defined environment are discarded.

In an embodiment the measurements are sent to the gateway through one or more of the relay nodes, wherein each relay node stores the measurement in case of a disconnection and is able to send the measurement when reconnected.

In an embodiment during a time in which a relay node is unable to receive measurements from the mobile device, the last known location, momentum of the mobile device and the stored valid locations/areas are used to predict the location of the mobile device until measurements from the mobile device are received again.

According to an aspect of the present invention there is provided method of connecting mobile devices to a local area network comprising a plurality of relay nodes, the method comprising:
transmitting a signal between a mobile device and a second transceiver of one of the relay nodes;
determining location information based on the transmitted signal;
transferring the determined location information from the second transceiver to a first transceiver of the respective relay node;
communicating the location information with one or more other relay nodes over a chain of connections between the respective relay node and one or more of the other relay nodes to an upstream server.

In an embodiment the location information is communicated point to point across a plurality of the relay nodes, each having a node to node connection, thereby forming the chain of connections.

In an embodiment the respective relay node receives a message/data from the upstream server. In an embodiment the message/data is transferred across the chain of node to node connections. In an embodiment the respective node transfers the message/data from the first transceiver to the second transceiver. In an embodiment the respective node transfers the message/data to the mobile device.

In an embodiment the respective relay node stores the data and/or location information prior to transmission. In an embodiment the buffering is for communication upstream and downstream. In an embodiment the storing is of a file comprising the data and/or location information. In an embodiment the method comprises storing the file in a file system until the file is acknowledged as being received by the next node in the chain of node to node connections.

According to an aspect of the present invention there is provided a method of providing a local area network comprising a plurality of relay nodes, said method comprising: transmitting a signal between a mobile device and a transceiver of one of the relay nodes; determining location information based on the signal; and forming a connection to at least one of the relay nodes, which forms a connection to an upstream server via a gateway to another area network;
wherein the connection is formed along a single path along a chain of connection;
wherein each relay node transfers the location information to the upstream server via the chain of connections.

In an embodiment the transceiver of each relay mode operates as a Peripheral when communicating across a connection to a downstream relay node. In an embodiment the transceiver operates as a Central when communicating across a connection to an upstream relay node.

According to an aspect of the present invention there is provided a method of communication across a data network comprising a gateway for connection to an external network and a plurality of spatially separated relay nodes capable of wirelessly communicating with at least two other relay nodes, the gateway and a mobile device, the method comprising: connecting the gateway to one or more first hop downstream relay nodes;
connecting each first hop downstream relay nodes to one or more further downstream nodes or further lines of downstream nodes; wherein data is transmitted between the gateway and each mobile device only through relay nodes along a single path that connects the gateway to the mobile device while each connection between the gateway and the mobile device is in place.

In an embodiment the connection remains in place while a data connection requirement between nodes is met. In an embodiment the data connection requirement is met when a heartbeat signal is received within a timeframe.

In an embodiment in the event that one or more of the connections between relay nodes does not meet the data connection requirement then each connection between nodes that does not meet the data connection requirement is severed and then sequentially, each relay node that severed the connection seeks to make a connection to the one or more relay nodes that have connections severed.

In an embodiment the establishment of a connection seeks to have the least number of hops from the gateway to the unconnected relay node via other relay nodes.

In an embodiment received data is stored until successfully transmitted to the either the server or the next upstream relay node, or to the gateway (in the upstream direction) or the next downstream relay node or to each mobile device connected to the relay node (in the downstream direction).

According to an aspect of the present invention there is provided a method of communication across a data network comprising a gateway for connection to an external network and a plurality of spatially separated relay nodes capable of wirelessly communicating with at least two other relay nodes, the gateway and a mobile device, the method comprising: connecting the gateway to one or more first hop relay nodes downstream of the gateway; each first hop replay node broadcasting availability to connect;
connecting a downstream relay node to only one first hop node;
connecting a mobile device to a downstream relay node or to one or more further downstream relay nodes; wherein data is transmitted between the mobile device and the gateway only through relay nodes along a single path that connects the mobile device to the gateway while each connection between the gateway and the mobile device is in place.

In an embodiment in the event of a break in the path, re-establishing a single path connection to the gateway.

According to an aspect of the present invention there is provided a network node connection method comprising:
connecting a gateway connectable to another network to one or more relay nodes;
connecting each relay node to one or more network enabled mobile devices or one or more other relay nodes;
wherein the connection of each relay node to the gateway node is via the least number of other relay nodes;
wherein when a relay node is disconnected from a path to the gateway node the relay node attempts to connect to one of the other relay nodes to establish a connection to the gateway node or to one of the relay nodes connected to the gateway node.

In an embodiment each relay node buffers transmitted data files such that in the case of a connection to the gateway being broken the data files are later retransmitted once the connection to the gateway is re-established.

According to an aspect of the present invention there is provided a method of determining a location comprising
storing in a server valid locations or areas of a mobile device within a defined environment;
connecting a gateway to the server;
connecting a connection based network of spaced apart point relay nodes at known locations to the gateway;
obtaining a measurement being an estimate of a location of a mobile device relative to itself at one or more of the relay nodes;
sending the measurement via the connection based network to the gateway and then to the server;
receive one or more measurements at the server and determining an estimated location of the mobile device based on one or more measurements, locations of the or each of the relay nodes and the valid locations or areas.

In an embodiment the method further comprises providing a visualization of location of mobile device relative to the relay nodes in the context of the location of the relay nodes. In an embodiment the context of the location is a tunnel. In an embodiment the visualisation is mapped to a topology of the location.

The above statements are intended to describe aspects of the inventive concept(s) which may be according to an individual statement or combinations of them. Other aspects, preferred forms and advantages of the present invention will be apparent from the present specification including the detailed description, drawings and claims.

### DESCRIPTION OF DRAWINGS

In order to provide a better understanding of the present invention example embodiments will now be described in reference to the accompanying drawings, in which:

FIG. 1 is a schematic visualisation of a network installed in a location according to an embodiment of the present invention;

FIG. 2 is a tree diagram of relay nodes of an embodiment of the present invention connected according to an embodiment of the present invention;

FIGS. 3A, 3B and 3C are a set of tree diagrams showing failure of a relay node and recovery according to an embodiment of the present invention;

FIG. 4 is a schematic visualisation of the network of FIG. 1 with a failure of a relay node and recovery according to an embodiment of the present invention;

FIG. 5 is a functional block diagram of a relay node according to an embodiment of the present invention;

FIG. 6 is a diagram showing messages establishing a connection between relay nodes according to an embodiment of the present invention;

FIG. 7 is a diagram showing messages sent between relay nodes according to an embodiment of the present invention;

FIG. 8 is a further diagram showing messages sent between relay nodes according to an embodiment of the present invention; and

FIG. 9 is a further diagram showing messages sent between relay nodes according to an embodiment of the present invention.

### DESCRIPTION OF EXAMPLE EMBODIMENTS

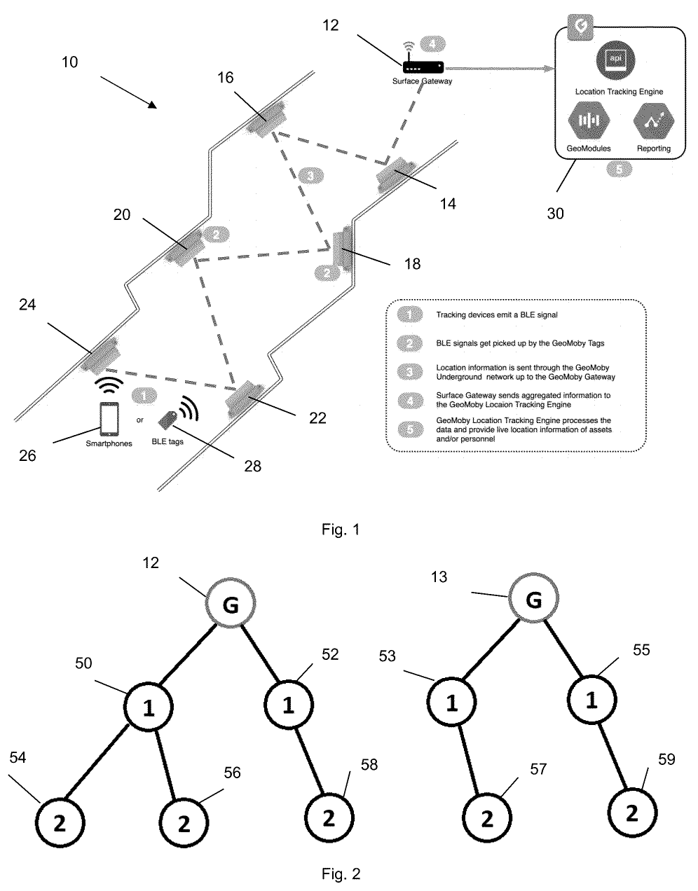

Referring to FIG. 1, there is shown a local area network 10 comprising a plurality of relay nodes 14, 18, 20, 22, 24. The network 10 connects to a gateway 12 for connection of a server 30 to one or more mobile devices, in this example a mobile smartphone 26 and a Bluetooth location tag 28, also known as a beacon. Other examples are possible such as an IoT sensor, for example a Bluetooth enabled gas sensor.

In an embodiment the relay nodes 14, 18, 20, 22, 24 are positioned at known locations. In this example the relay nodes 14, 18, 20, 22, 24 are positioned in a tunnel or network of tunnels, such as in an underground mine, although other environments are anticipated, such as a warehouse. The tunnel of FIG. 1 is not to scale, or proportion. In a real world situation it is likely to be proportionally much longer and also not likely to be of the same zig-zag configuration.

In an embodiment the relay nodes 14, 18, 20, 22, 24 are positioned apart from one another such that each is within wireless communication range of at least two other of the relay nodes 14, 18, 20, 22, 24. For example relay node 16 is within range of relay nodes 14 and 18. A relay node at the end of a line may only be in range of one other relay node but this is undesirable. Preferably each relay node is in range of at least two upstream relay nodes and two downstream relay nodes so as to handle a disruption to communication in one or more of the relay nodes, as described further below.

While not shown, a tunnel system may have a stub, alcove or a branch. The nodes 14, 18, 20, 22, 24 may be positioned throughout the tunnel system so as to substantially cover a desired area of the tunnel system.

The locations of the nodes 14, 18, 20, 22, 24 in the tunnel system (or other location) and preferably the topography of the tunnel system (or other location) is known/determined and preferably saved in the server 30. Often the tunnel system will be surveyed and its topography will the known with high accurately. However, in other situations the topography will be unknown and all that can be determined is the distance into the tunnel from a reference point(s).

In FIG. 1 a wireless connection is established across a number of hops from the server 30 to the gateway, through nodes 14, 18, 20, 22, 24 to the devices 26 and 28. The first node 14 and the gateway 12 have a wireless connection and each node 18, 20, 22 has a connection to the adjacent nodes, upstream and downstream respectively, and node 24 is connected to node 22, as indicated by the dashed line. In an embodiment this wireless connection is established using the Bluetooth Low Energy (BLE) protocol and preferably BLE 5 as it allows long range, high through put in a (radio) noisy environment. However BLE is not typically used for handling large amounts of data, such as data file transfer, especially for longer ranges where the data transfer rate drops. BLE is also typically only used in a one point to one point topology, where one of the points is a gateway if connection to another network is required. The one to one connection may be one connection of a hub and spoke configuration, with the hub being the gateway.

The connection from the gateway 12 to the server 30 may be wired or wireless, typically by WiFi or ethernet.

The connection of node 24 to device 26 is indicated by the adjacent set of three arcs indicating a radio signal (preferably in the 2.4 GHz band use by BLE) and the connection of node 22 to device 28 is also indicated by the adjacent set of three arcs, also indicating a radio signal.

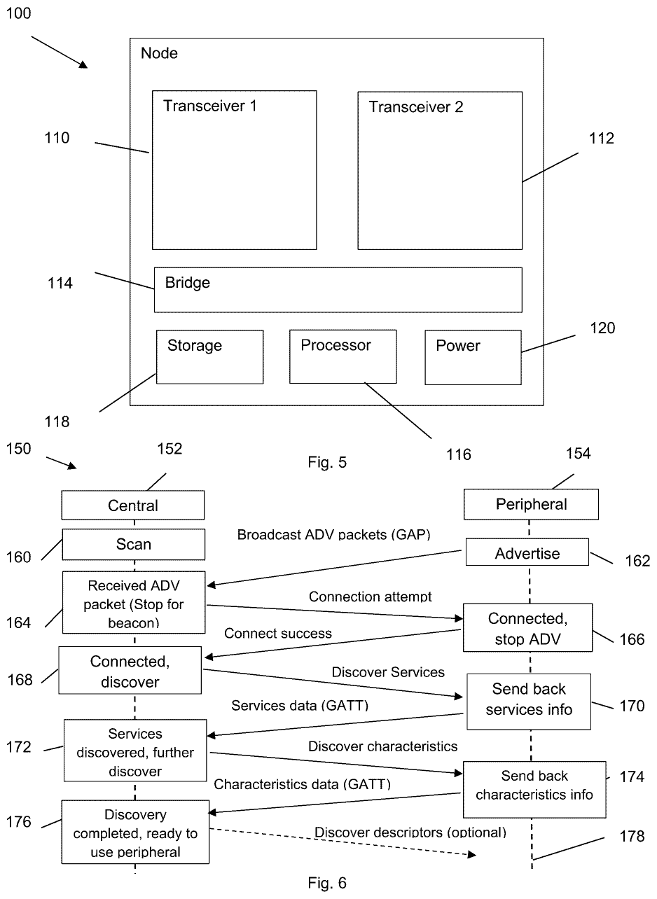

Each relay node 14, 18, 20, 22, 24 comprises a first transceiver (110 in FIG. 5) for communicating with one or more other relay nodes so as to establish the multi-hop communication pathway (or single hop in the case of relay node 14). Each relay node 14, 18, 20, 22, 24 comprises a second transceiver (112 in FIG. 5) for communicating with one or more mobile devices 26, 28 so that each node is able to communicate with the devices 26, 28 wherever they may be positioned in the tunnel network (or other type of location). For example, if the device 26 is near the opening of the tunnel it may be in range of and can communicate with node 14. Further into the tunnel it may be in range of and can communicate with, for example, node 18 and near the end of the tunnel is may be in range of and can communicate with node 24. As described further below, each relay node may implement only one physical transceiver.

Preferably the connections are established as communication tunnels over BLE 5. Notably the connections between relay nodes are point to point connections (also known as unicast connections) and are not broadcasts of the message/data to any other relay node that is listening. This is in contrast to a mesh network which broadcasts data transmission to all receivers in range in order to transfer data using a flood fill approach. With a connection based approach, a path is established between a source (server 30 or device 26, 28) and a destination (device 26, 28 or server 30, respectively depending on the direction of the data), which may be via multiple hops, and the transmission of data is singe node by single node for each hop across a chain of the connections between nodes across the path. The topology employed is tree based rather than mesh based.

Referring to FIG. 2, there may be more than one gateway 12, 13 each of which is connected to another local network, wide area network or internet for connection to the server 30.

In this example nodes 50, 52, 54, 56 and 58 connect via the gateway 12 and nodes 53, 55, 57 and 59 connection via gateway 13. The gateways 12, 13 may connect to a single server 30. The gateway 12 is wirelessly connected to nodes 50 and 52 and they are each 1 hop away from the gateway 12. Each of nodes 54 and 56 are wirelessly connected to node 53 and nodes 54 and 56 are 2 hops away from the gateway 12. Node 58 is wirelessly connected to the node 52 and it is 2 hops away from the gateway 12. The gateway 13 is wirelessly connected to nodes 53 and 55 and they are each 1 hop away from the gateway 13. Node 57 is wirelessly connected to node 53 and node 57 is 2 hops away from the gateway 13. Node 59 is wirelessly connected to the node 55 and it is 2 hops away from the gateway 13.

In an embodiment the connections are established so as to have the least number of hops to the gateway 12, 13. For example, node 56 does not connect to the gateway 12 via node 58 because it would be 3 hops from the gateway 12.

In some embodiments, another methodology may be used for determining which node are connected, either in combination with the least hops approach or instead. When creating connections between nodes a longer path by hops between nodes may be accepted when there is a better signal to noise ratio (SNR) of the wireless signal, lower data loss or the data transmission rate to do so is better. When there is a choice of relay nodes to connect to, the connection will typically be established with the upstream relay node with the strongest signal strength (or best SNR). However the server 30 may instruct a relay node on which node it is to connect to (or which node is to accept a connection from).

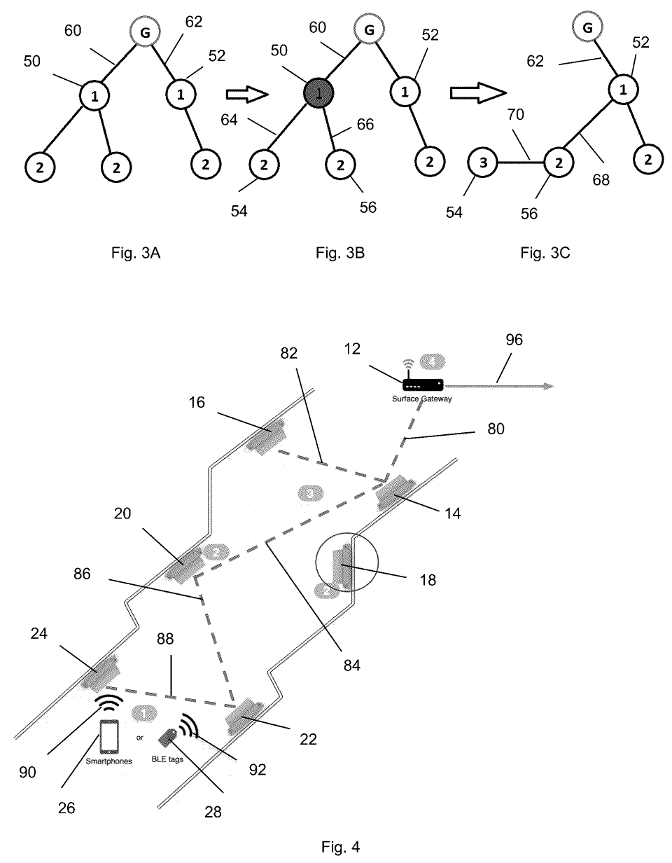

In some environments, connections may be interrupted, either because of transmission interference or blockage (such as a piece of mining machinery passing by the relay node or blocking the transmission) or a relay node may be inoperative. For example, in FIG. 3B node 50 becomes inoperative or its signal strength is too low.

When a connection is lost or dropped because of loss of signal reliability (or because of a better signal reliability becoming available), a new connection is attempted. Depending on the configuration and transmission range a device 26, 28 may still be able to establish a connection to another of the nodes 50, 52, 56, 58. For example, node 56 might be in range, while other nodes 50, 52, 58 may not be in range.

Referring to FIGS. 3A to 3C, an end point node may not be the node that is inoperative as is the case in FIGS. 3B and 3C. In this example relay node 50 becomes inoperative. Connection 60 between the gateway 12 and node 50 (FIG. 3A) would then go down. In turn connections 64 and 66 between node 50 and node 54 and 56, respectively, (FIG. 3B) would thus go down. However, in this example node 56 is still in range of node 52. So, (in FIG. 3C) the connections 60, 64, 66 would be replaced with connections 62, 68 and 70, between the gateway 12 and node 52, node 52 and node 56, and node 56 and node 54, respectively. Thus, nodes 54 and 56 could re-establish a path to the gateway 12. However, node 54 is now 3 hops from the gateway 12.

A similar situation could arise if the connection 60 when down, even though node 50 might still be operational. In an example the same result in reestablishment of connections would occur as in FIG. 3C.

In the case of interference of transmission abating or the inoperable node becoming operable again, the affected node will attempt to re-establish a pathway of a chain of one or more connections to the gateway 12.

When node 50 can reconnect to the gateway 12, any data held stored by the node 50 can then be sent. But also any data part sent to node 50 by node 54 or node 56 is resent via node 52.

Further, in an embodiment, if a downstream node is able to establish a pathway to the gateway 12 via a smaller number of hops it will do so. Alternatively, a path to the gateway 12 may be established by each connection between nodes providing the best available data transfer rate, lowest SNR or by other criteria. In the least hops configuration, when relay node 50 is operable again (or is not blocked), after node 50 connects to the gateway 12, then node 54 will be able to determine that re-establishing the path to gateway via node 50 will have fewer hops and it would thus disconnect from node 56 and connect via node 50. Node 56 might remain connected to node 52. However, if data throughput (typically determined by signal strength) is higher via node 50 then it may disconnect from node 52 and connect to node 50.

FIG. 4 likewise illustrates node 18 becoming inoperable or its transmission to the node 16 is blocked or otherwise interfered with (including a data transfer rate dropping below a threshold). Node 22 is in range of node 14 so a connection 84 is established between nodes 14 and 20. Thus by establishing connection 84, device 26 can communicate with the server 30 by the chain of connections 90, 88, 86, 84, 80 and 96. Device 28 can communicate with the server 30 by the chain of connections 82, 86, 84, 80 and 96.

A connection dropping/severing criteria may be provided. Typically, this may be by timeout of a heartbeat signal (such as a ping message), or drop in data transfer rate below a threshold or packet loss above a threshold, or a combination. In an embodiment the connection may be severed when a better connection (such as with a better signal strength) is available.

A health status message may be used instead of a heartbeat signal. The health status may be sent periodically from each relay node to the server 30, say every 2 min, 5 min or 10 mins. The health status may comprise the battery level of the relay node, upstream and downstream connected nodes' received signal strength. Each relay node may be identified by its upstream MAC address as a unique identifier of the node. The health status may also comprise any error messages/codes.

In the heartbeat example, the data connection requirement is not met when all data transmitted to the next relay node goes unacknowledged for a predetermined period of time (that is, the destination relay node cannot be ‘seen’ during that period of time). The time may be for example, 5 sec, 10 sec, 20 sec, 30 sec, 40 sec, 50, sec or 1 min. The data connection requirement is met when the data transfer rate is at least a predetermined rate. Depending on implementation, the data connection requirement may not be met when the data transfer rate drops below a second predetermined rate.

A prioritization of connection establishment criteria may be provided. Typically, this may be interruption is removed such that a heartbeat signal can be re-established and the number of hops from the gateway to the node is fewer than a current number of hops or a connection can be established to another node that provides a larger data transfer rate than currently achieved.

Referring to FIG. 5, in one embodiment, each relay node 100 comprises a first transceiver 110 and a second transceiver 112. The transceivers 110 and 112 may be functional modules of a single physical transceiver. As noted above, the first transceiver 110 is for communicating with one or more other relay nodes and the second transceiver 112 is for communicating with one or more mobile devices. In another embodiment there is only one transceiver and no bridge.

The relay node 100 further comprises a processor 116 for determining location information based on a signal transmitted between the second transceiver 112 and the or each mobile device. The location information may be a signal strength, or may be calculated therefrom. For example, the location information may be a distance of the or each mobile device from the mode 100. The relay node 100 also comprises a bridge 114 for transferring data between the first and second transceivers 110, 112.

In an embodiment the relay node 100 comprises a storage 118 for buffering the data and/or location information prior to transmission by the first transceiver 110 to the upstream server 30. This buffering is distinguished from any short term buffering occurring during retransmission. The buffering is substantive storage of a data file, not transient nature of a data packet. The storage 118 holds the data until full transmission is completed and acknowledged. The data file is able to be retransmitted via a different connection if the current upstream connection is severed mid-transmission. Data stored in the storage may be stored in a file system, so that a plurality of data files can be stored in an organised manner. For example, the little FS library may be used.

The bridge 114 may implement the storage 118 such that data transferred between the transceivers 110 and 112 may be stored in the storage 118 until an acknowledgement is received that the data has reached its destination (or next hop in the network 10).

Each relay node also has a power source 120, such as a battery, preferably a long life, high capacity battery. For example, a 12V 120Ah Lithium Ion battery may be used, which lasts about 10 to 12 months.

In an embodiment the processor 116 is configured to form a connection to the upstream server 30 via each the respective first transceiver 110 of each upstream relay node (such as 14, 16, 18, 20, 22 starting from 24) or the gateway 12, 13. In an embodiment the processor 116 is configured to transfer the location information to the upstream server 30 via the chain of connections. Thus, each relay node in communication with one of the devices 26, 28 is configured to transfer data from the respective device to the upstream server 30 via the chain of connections and the data from the respective device 26, 28 and the location information is transmitted via the chain of connections.

In an embodiment the first transceiver 110 connects to a downstream other one or more of the relay nodes (such as 16, 18, 20, 22, 24 starting from 14) for connection of the downstream relay node to the upstream server 30.

In an embodiment each relay node 14, 16, 18, 20, 22, 24 is configured to receive a message/data from the upstream server, preferably by use of the first transceiver 112. The message/data may be for example an audio, video or text message.

In an embodiment when the message/data is for a destination that is another one of the rely nodes or device connected to one of the other relay nodes the message/data is sent to the relay node that is, or is connected to, the destination. This the message/data cascades up to the server 30 or down from the server 30, relay node by relay node, with the message/data being stored at each hop on the way. That way if there is an interruption, when the interruption is abated, the transfer can recommence without loss of the data. While a message or data file is broken up into packets for transmission within a packet payload limit, it is reassembled into the file at each relay node and preferably stored in a file system in the node. This permits redirection of the file, or mobile device (or other device, such as an IoT sensor) to mobile device transfer without need to route through the server. Contrast this with sending each packet across the chain of connections to and from the server without reassembly into the file at each node.

In an embodiment the first transceiver 110 and the second transceiver 112 may be implemented as logically separate transceivers by a single physical transceiver by multiplexing the respective transmissions and receptions, and by scheduling the respective logical functions into to actions of the single physical transceiver. Each relay node requires a connection event to receive/transmit data and there is a connection interval between connection events. When implementing the single physical transceiver both transmit and receive actions can be performed in the connection event by appropriate scheduling of the actions of the transceiver.

With a survey of the tunnels system and the location of the mobile devices the location of the mobile device can be represented in a visualization of the tunnels. The ability to do this is understood to be unknown. This occurs by providing a data set representing the 3D position of the tunnels, such as might be acquired by LIDAR mapping the tunnel. Then with the ability to locate the device (which could be associated with a person or asset, such as a machine) the location of the asset or person can be displayed within a 2D or 3D map of the tunnels system. This is of significant benefit for management of assets and for safety. Obviously, this is also applicable in other environments, such as a warehouse. The mapping can also be used to designate areas in which it is possible (valid), such as in a corridor/tunnel, or impossible (invalid) such as inside a wall, for a location of a mobile device. It also allows line of sight of a relay node to be determined.

The network 10 facilitates:
Transmitting beacon 28 observations to the application server 30;
Transmitting messages from the application server 30 to the smartphones 26 (individual or to many at once);
Transmitting files (audio/pictures) from the underground mobile devices 26 (smartwatch, smartphones . . . ) to the application server 30.
Transmitting files (audio/pictures) from application server 30 to underground mobile devices 26
Transmitting files between two underground mobile devices, that is, from device 26 to another device 26.

The connection-based network is understood to be able to achieve higher data transfer speed than a known broadcast based mesh network approach at larger spacing between the relay nodes.

In an embodiment the connections between the gateway 12 and the relay nodes 14 to 24 and between relay nodes 14 to 24 uses Bluetooth protocols. Preferably BLE 5 is used.

In an embodiment the connection to the devices 26, 28 from each relay node 14, 16, 18, 20, 22, 24 use Bluetooth protocols. In an embodiment BLE 4 is used as there is readily available beacons that use BLE 4. BLE 4 does not support PHY modes 2M and CODED.

In an embodiment the gateway comprises a Nordic nRF52840 System on a Chip (SoC) board with a WiFi module to establish connection 96 to the server 30. The gateway 30 is connected to the closest relay node (node 14) by BLE 5.0 connection.

The gateway 12 may not store data files. It acts as a proxy between the network 10 and the application server 30. However, in an alternative the gateway 12 is implemented with a buffer of packet data to help manage flow of data through the gateway 12 and avoid packet loss.

In an embodiment each relay node comprises a Nordic nRF52840 (SoC) board with Nordic nRF52832 (SoC) board attached to provide the power supply 120 and communication. The Nordic nRF52840 operates as the first transceiver 110 and the Nordic nRF52832 operates as the second transceiver 112. In other examples, the Nordic boards may be replaced with Arduino or Raspberry Pie boards. Other appropriate SoCs may also be used.

The Nordic nRF52840 implements the features:
Connecting to the neighbour nodes;
Transmitting the beacon's (device 28) observation to the gateway 30 (own and the ones which were transmitted by the other nodes after this one);
Transmitting the data (image, file, audio for example), received from a phone (device 26), connected to this node;
Transmitting the data (image, file, audio for example), received from a phone (device 26), connected to a node after this one;
Transmitting and storing the messages from the application server 30.

The Nordic nRF52840 also provides the storage 118 implemented using a Reliance Edge filesystem is used to store the messages, and data files.

The Nordic nRF52832 implements the features:
Observing the beacons (device 28);
Sending the observations to nRF52840 to send it over the network;
Receiving the data (image, file, audio for example) from a connected smartphone (device 26) to send it over the network;
Sending messages to a destination smartphone (device 26) once it gets in the range of the node.

The Nordic nRF52840 and Nordic nRF52832 are connected via the bridge 114, which may be implemented as communication interface, such as Serial Peripheral Interface.

The Nordic nRF52840 has a processor which acts at least in part as processor 116 for control of the operation of the relay node. The Nordic nRF52832 also has a processor which may also act at least in part as the processor 116 for control of operation of the relay node. One of the processors of each Nordic System on a Chip board may acts as the master (also called Control), while the other acts as a slave (also called Peripheral).

In an embodiment single physical transceiver is implemented by the nRF52840 and the nRF52832 functions are also performed by the nRF52840 with appropriate scheduling so as to achieve both logical roles.

The device 26 may be a smartphone, such as an Android smartphone with a dedicated Android application installed thereon for handling the instigation of and receipt of communication, via the smartphones operating system and hardware (including a Bluetooth transceiver). Other example devices 26 include an iOS device or smartwatch or other Internet of Things enabled device (such as for example a gas sensor). The smartphone is used to:
Send pictures over the network
Receive the messages
Transmit audio and video files.

The server 30, or in some instances the processor 116 could, determine the location of the device 26, 28 relative to the node 14, 16, 18, 20, 22, 24. Preferably the location information is at least a distance from the node determined from one or both of Time of Arrival of the signal and signal strength of the signal form the device 26, 28. The distance information may be collated with distance information from another node, if available. However frequently it will only be the case that the distance information is available because the distance ranging is smaller than the distance achievable between nodes. A Monte Carlo localization (also known as particle filter localization) determining algorithm may be used to determine location based successive distance measurements. The algorithm uses probabilistic approximation of a location that iteratively filters out lower probability locations based on only the distance measurement as the device moves (and thus its distance changes), until a good estimate of the location is determined with a high probability. This algorithm has been determined to be accurate to about 2-5 metres, although this may vary depending on density of locators around a beacon/smartphone. The algorithm may allow one or more of the following parameters to be varied:
Measured Noise amplitude;
Weighting threshold (specific parameter for sampling procedure);
Number of samples we take every run (defines the accuracy of the output);
Number of historical observation data to maintain for each run or windowed observation parameter (would help to get an accurate output quicker); and
Particle filter frequency.

Additionally, a speed of movement and momentum algorithm can be applied in the Monte Carlo localization or between when distances can be determined to estimate a location. In an embodiment when there is a mapping of the environment positions, possible predicted locations that are invalid can be eliminated from the possibilities, in other words the possibilities can be constrained to valid locations.

Typically, for linear deployments, the distance between relay nodes may be 250 m to 300 m with line of sight. The example device has a theoretical range of 1.3 km, so the distances between relay node may be more depending on operating conditions. A distances of 400 m and 600 m have been achieved with line of sight in a test environment. A distance of 100 m to 150 m between nodes when there is no line of sight between relay nodes can be used, but this may depend rock thickness and mineral content through the direct line between relay nodes. No line of sight may be used in low density beacon coverage, such as in a long tunnel. However in high density beacon coverage, such as in a work area, so as to increase accuracy, less accurate estimates from nodes that do not have line of sight may be given less weight or eliminated.

Typically, the range of each relay node to device 26, 28 is up to about 30 m to 40 m. This may be greater, say to 60 m or 150 m depending on the beacon's transmission power and calibration. Where continuous coverage is desired additional relay nodes can be placed, so as to fill gaps in coverage or to increase the number of nodes that can report the location of the devices 28 and thus the accuracy, particularly in a location in which many devices may be present. For example, at a mining face in the tunnel where many people may be working. The determined location can be sent back to the mobile device, for example to use in a map application, which his particularly useful when the other location services of the mobile device, such as GPS or cellular telephone base station or WIFI location services are unavailable. The determined location can also be used by for example a mine operator for use in productivity measurement, or in an emergency situation.

In an embodiment the first transceivers of connected relay nodes use the physical layer configuration (PHY) according to their spacing. Long range spacing (about 200 m, 300 m, 400 m, 500 m or 600 m, for example) use CODED PHY, medium range spacing (about 100 m) use 1M PHY and short range spacing (about 50 m, 60 m, 70 m or 80 m) use 2M PHY. In another embodiment CODED PHY may be used above 100 m spacing and 2M PHY at or below 100 m spacing. The configuration may be set from the server 30 and a configuration command sent to each relay node as they are connected into the network after power up. The server 30 may dynamically choose the best connection mode based on signal strength and connected state stability. Priority for each node can also be controlled by the service configuration (downstream message) coming from the cloud server 30.

Referring to FIG. 6, which shows a method of 150 of establishing a wireless communication connection between a Central device 152 and a Peripheral device 154. The method commences by the Central device 152 scanning 160 for an advertisement (ADV) of the Peripheral device 154. The Peripheral device 154 sends 162 a broadcast of advertisement packets when it is powered on and ready. When the ADV is received at 164 the Central device 152 knows that the Peripheral device is present. In the case of the Peripheral device 154 being a beacon the method does not progress, rather the identify of the beacon is known and can be reported. Otherwise, the Central device 152 can then commence the connection. It does so by sending a connection attempt message. The Peripheral device 154 on receive of the connection attempt message, ADV message was received, the ADV message is stopped at 166. A connection success message is sent to the Central device 152. The Central device 152 now knows that the connection was successful at 168 and it sends a discover services message to the Peripheral device 154. On receipt of this the Peripheral device 154 sends at 170 services information to the Central device 152. At 172 the Central device 152 has now discovered the services of 152 and can require characteristics. On receipt the Peripheral device 154 sends back at 174 the characteristics data. On receipt at 174 the Central device 152 has discovered the Peripheral device 154 and can now use the peripheral device 154 at 178. Optionally descriptors may also be discovered.

Each node may use an advertising phase (ADV) when it announces on a broadcast basis that it is connected to the gateway as well as its distance to the gateway. If a node is unconnected or is connected to another node more hops away from the gateway than the current node it is connected to, then the node may disconnect from the current node and then connect to the node with the fewer number of hops and in an embodiment the strongest signal strength. Once connected and the announce phase is concluded the nodes may perform a transmit phase where they transmit upstream to the upstream connected node and downstream the one or more downstream nodes connected thereto. The nodes may alternative between these phases according to the timing provided by the Service Configuration coming from the cloud server.

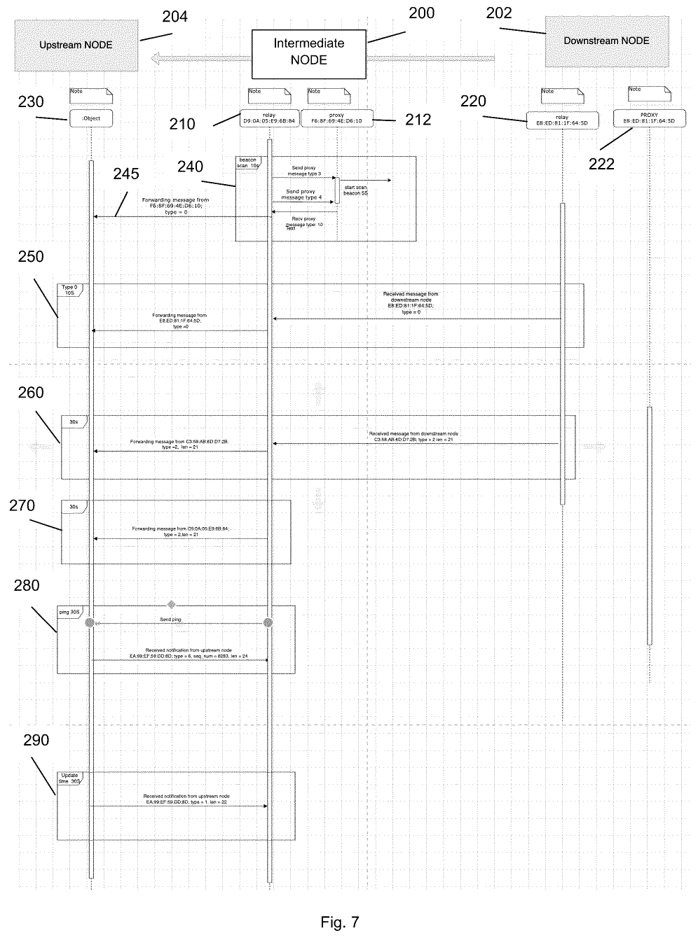

Referring to FIG. 7, which shows a message exchange between a downstream node 202 and an upstream node 204, via an intermediate node 200. The upstream node 204 has is first transceiver 230 shown, which may be implemented as the nRF52840 as described above. The downstream node 202 has is first transceiver 220 and second transceiver 222 shown, which are may be implemented as the nRF52840 and nRF52832, respectively, as described above. The intermediate node 200 has is first transceiver 210 and second transceiver 220 shown, which may be implemented as the nRF52840 and nRF5232, respectively, as described above. The first transceivers 210 and 220 act as relays and the second transceivers 212 and 222 act as proxies for the relays to the devices (beacons). The first transceiver 230 acts as the object of the transfer from the downstream node 202 to the upstream node 204. Alternatively, the first transceiver 210 and second transceiver 220 may be implemented by logical/virtual tasks conducted by a single transceiver of a nRF52840 with appropriate scheduling.

Relay 210 initiates a beacon scan 240 for 10 s by messaging the proxy 212, which starts scanning for beacons for 5 s. A further message from relay 210 prompts a reply message from the proxy 212 with the result of the scan (observation). An observation message 245 is sent from the relay 210 to the relay 230.

Relay 220 initiates an observation message transfer 250 for 10 s by sending from the relay 220 an observation message to the relay 210, which is in turn sent from the relay 210 to the object 230.

Relay 220 initiates a ping request transfer 260 for 30 s by sending from the relay 210 a ping request message to the relay 210, which is in turn sent from the relay 210 to the object 230.

Relay 210 initiates its own ping request transfer 270 for 30 s by sending from the relay 220 a ping request message to the object 230.

Relay 210 initiates a ping transfer 280 for 30 s by sending from the relay 220 a ping message to the object 230, which responds with a ping respond message to relay 210. The Ping acts as the heartbeat, which is used to know the health status of the network. It carries information such as battery level, any hardware/software errors and connection mode and is reported to the server 30.

Object 230 initiates a settings transfer 290 by sending from the object 230 a settings message to the relay 210.

The health status of the whole network and each relay node therein can be monitored from the server to identify maintenance (for example battery replacement), weak links (which may need to be repositioned) or other abnormal behaviour.

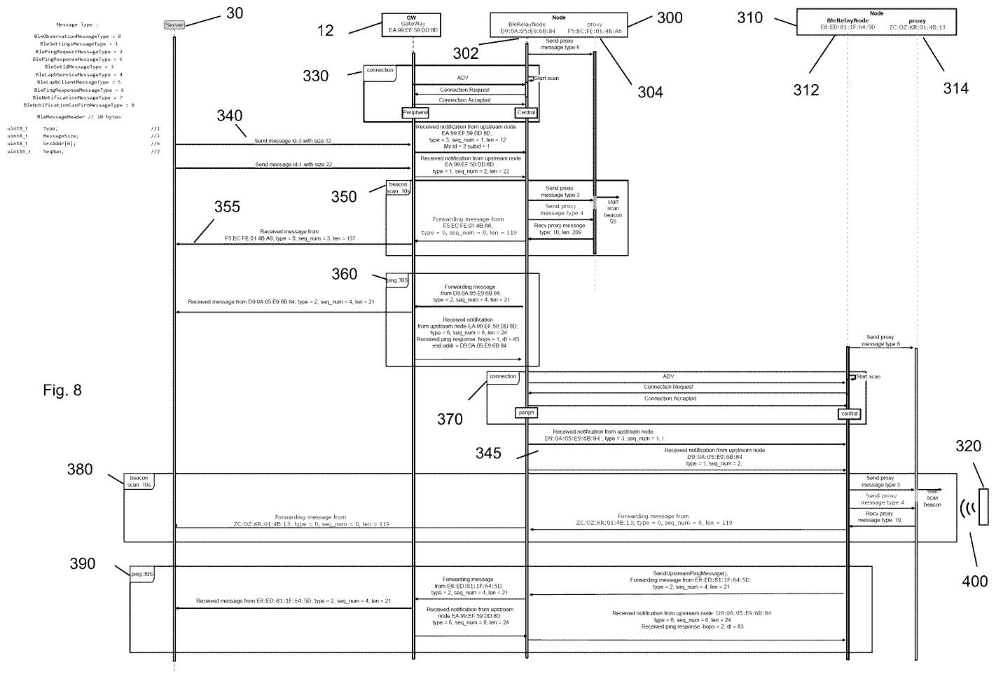

Referring to FIG. 8, which shows message exchange between a downstream node 310 and the server 30 via the gateway 12 and an upstream node 300, as well as a mobile device 320 (beacon). The upstream node 300 has is first transceiver 302 shown, which is preferably implemented as the nRF52840 as described above and is referred to as a relay, and second transceiver 304, which is preferably implemented as the nRF52832 as described above and is referred to as a proxy. The downstream node 310 has is first transceiver 312 and second transceivers 314 shown, which are preferably implemented as the nRF52840 and nRF52832, respectively, as described above and are referred to as relay and proxy respectively.

The relay 302 sends a ping message to the proxy again to acts as the heartbeat.

Gateway 12 initiates a connection transfer 330 with the node 300. The relay 302 sends a connection request message to the gateway 12 and the gateway 12 responds.

At 340, the server 30 sends a set id message to the gateway 12 which is then transferred to the relay 302 and then a settings message which is also transferred to the relay 302.

Relay 302 initiates a beacon scan 350 for 10 s by messaging the proxy 304, which starts scanning for beacons for 5 s. A further message from relay 302 prompts a reply message from the proxy 304 with the result of the scan (observation). An observation message 355 is sent from the relay 302 to the gateway 12 and then to the server 30.

Relay 302 initiates a ping request transfer 360 for 30 s by sending from the relay 302 a ping request message to the gateway 12 and then to the server 30. The gateway 12 responds to the relay 302.

Relay 302 initiates a connection transfer 370 with the node 310. The relay 302 sends a connection request message to the relay 312 and the relay 312 responds.

At 345, the relay 302 sends a set id message to the relay 312 and then a settings message which is also transferred to the relay 312.

Relay 312 initiates a beacon scan 380 for 10 s by messaging the proxy 314, which starts scanning for beacons for 5 s. A further message from relay 312 prompts a reply message from the proxy 314 with the result of the scan (observation). An observation message is sent from the relay 312 to the relay 302 then to the gateway 12 and then to the server 30.

Relay 312 initiates a ping request transfer 390 for 30 s by sending from the relay 312 a ping request message to the relay 302, which is sent to the gateway 12 and then to the server 30. The relay 302 responds with a ping respond message to relay 312.

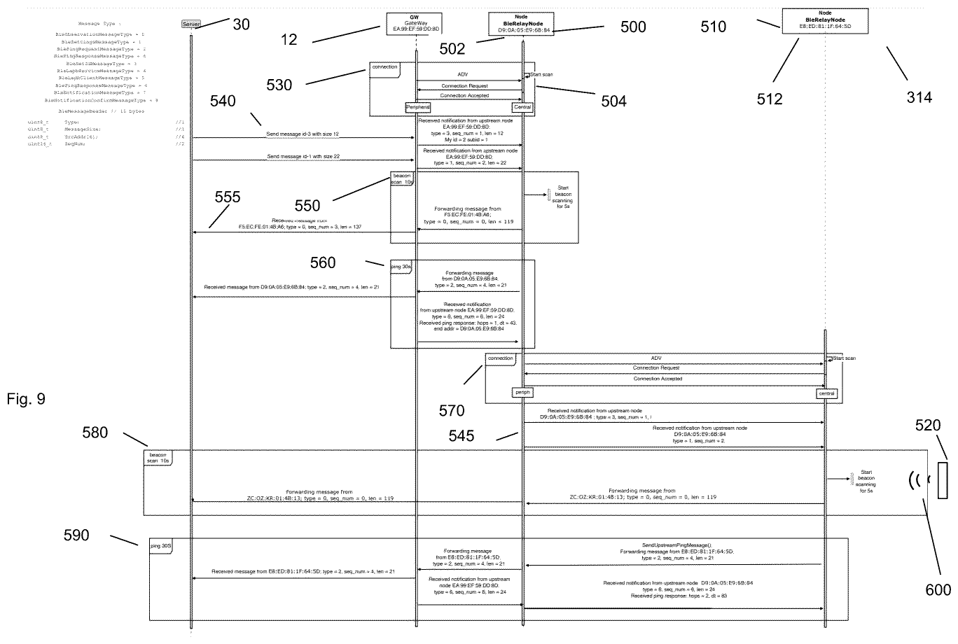

Referring to FIG. 9, which shows message exchange between a downstream node 510 and the server 30 via the gateway 12 and an upstream node 500, as well as a mobile device 520 (beacon). In this embodiment the functions of the first transceiver and the second transceiver are performed by a single physical transceiver. The upstream node 500 has the transceiver 502 shown, which is preferably implemented as the nRF52840 as described above and is referred to as a central when performing the first transceiver role and as a peripheral when performing the second transceiver role. The downstream node 510 has a transceiver 512, which is preferably implemented as the nRF52840, as described above and when a connection is established is referred to as a central.

The transceiver 502 performs a connection 530 to the gateway 12, assuming the node 500 is scanning. The gateway sends an ADV, broadcast to which ever node is listening, [cb1] which is received by transceiver 502. Transceiver 502 sends a connection control to the gateway 12, which responds with an acceptance message. The node then become a Central and the Gateway becomes a Peripheral.

At 540, the server 30 sends a set id message to the gateway 12 which is then transferred to the transceiver 502 and then a settings message which is also transferred to the transceiver 502.

Transceiver 502 initiates a beacon scan 550 for 10 s by messaging the proxy 504, which starts scanning for beacons for 5 s. A further message from transceiver 502 prompts the gateway 12 to message the server 10 at 555.

Transceiver 502 initiates a ping request transfer 560 for 30 s by sending from the transceiver 502 a ping request message to the gateway 12 and then to the server 30. The gateway 12 responds to the transceiver 502.

Transceiver 502 initiates a connection transfer 570 with the node 510, assuming the node 510 is scanning. The transceiver 502 sends a connection request message to the transceiver 512 and the transceiver 512 responds. The node 500 then adopts a Peripheral role and the node 510 adopts a Central role.

At 545, the transceiver 502 sends a set id message to the transceiver 512 and then a settings message which is also transferred to the transceiver 512.

Transceiver 512 initiates a beacon scan 580 for 10 s which starts scanning for beacons for 5 s. Transceiver 512 the result of the scan (observation of beacon 520 from signal 600). An observation message is sent from the transceiver 512 to the transceiver 502 then to the gateway 12 and then to the server 30.

Transceiver 512 initiates a ping request transfer 590 for 30 s by sending from the transceiver 512 a ping request message to the transceiver 502, which is sent to the gateway 12 and then to the server 30. The gate way responds to the transceiver 502 which responds with a ping respond message to transceiver 512.

The time periods noted in these examples may be changed by configuration settings send by the server 30. Other aspects of the configuration of the relay nodes may also be send from the server 30 to the relay nodes.

The network may be used to convey voice data to replace or complement 2-way UHF radio communication. In that case devices 26 may be ‘paired’ by a handshake procedure to as to provide 2-way communication (such as by using a push to talk application).

Alternatively, the radio application may broadcast to all receivers using the application in the same manner that a UHF radio transmits to all receivers able to receive the transmission. Here all receivers would be all devices 26 running the application and connected to the network 10.

The server or application on smartphone may be used to implement geofencing in the underground tunnel environment, previously believed to be unable to be achieved.

Quality of Service may be implemented on the transmissions between the relay nodes and between the relay node and the gateway 12. Packets of different types of data may be prioritized over other packets of different types of data. Location information (observations) may be provided the highest priority. A heartbeat signal used to determine that a connection is still in place may be given second priority. Other data may be given lowest priority. The priorities assigned to different data packet types may differ, for example the heartbeat packets may be given highest priority. The heartbeat signal may be sent every 30 s, for example.

The server 30 may implement functions of location tracking, geofencing, visualisation of locations, message and location logging and other reporting functions.

The server 30 may have an optimal configuration stored for the connections of the network and will send commands to the relay nodes to change to optimal configuration. However, this may be balanced against actual conditions at any given time. The server may monitor the actual conditions, such as inoperable nodes, blocked or attenuated or slower connections, number of hops and network usage. Based on this monitoring the server may issue adjustments to the relay nodes to make the best of current conditions.

It is to be appreciated that systems, components, interfaces and so forth can be provided in several forms. Systems, components, interfaces and so forth may be provided as hardware, software or a combination thereof. Aspects of and in particular the controlling methodology of hardware components of the present invention may be embodied as an electronics device, computer readable memory, a personal computer and distributed computing environments, a number of computer executable operations; a number of computer executable components; a set of process operations; a set of systems, facilities or components; a computer readable medium having stored thereon computer executable instructions for performing computer implemented methods and/or providing computer implemented systems; and so forth. In the case of computer executable instructions they are preferably encode the systems, components and facilities described herein. For example, a computer-readable medium may be encoded with one or more facilities configured to run an application configured to carry out a number of operations forming at least part of the present arrangements. Computer readable mediums preferably participate in the provision of computer executable instructions to one or more processors of one or more computing devices.

Computer executable instructions are preferably executed by one or more computing devices to cause the one or more computing devices to operate as desired. Preferred data structures are preferably stored on a computer readable medium. The computer executable instructions may form part of an operating system of a computer device for performing at least part of the preferred arrangements. One or more computing devices may preferably implement the preferred arrangements.

The term computer is to be understood as including all forms of computing device including servers, personal computers, smart phones, digital assistants, electronics devices and distributed computing systems.

Computer readable mediums and so forth of the type envisaged are preferably intransient. Such computer readable mediums may be operatively associated with computer based transmission facilities for the transfer of computer data. Computer readable mediums may provide data signals. Computer readable mediums preferably include magnetic disks, optical disks and other electric/magnetic and physical storage mediums as may have or find application in the industry.

Components, systems and tasks may comprise a process involving the provision of executable instructions to perform a process or the execution of executable instructions within say a processor. Applications or other executable instructions may perform method operations in different orders to achieve similar results. It is to be appreciated that the blocks of systems and methods described may be embodied in any suitable arrangement and in any suited order of operation. Computing facilities, modules, interfaces and the like may be provided in distinct, separate, joined, nested or other forms and arrangements. Methods will be apparent from systems described herein and systems will be apparent from methods described herein.

As would be apparent, various alterations and equivalent forms may be provided without departing from the spirit and scope of the present invention. This includes modifications within the scope of the appended claims along with all modifications, alternative constructions and equivalents. Modifications may be made to the present invention with the context of that described and shown in the drawings. Such modifications are intended to form part of the invention described in this specification.

There is no intention to limit the present invention to the specific embodiments shown in the drawings. The present invention is to be construed beneficially to the applicant and the invention given its full scope.

It is to be recognised that any discussion in the present specification is intended to explain the context of the present invention. It is not to be taken as an admission that the material discussed formed part of the prior art base or relevant general knowledge in any particular country or region.

1. A local area network comprising a plurality of self-powered relay nodes, each relay node comprising:
a first transceiver for communicating with one or more other relay nodes;
a second transceiver for communicating with one or more mobile devices; and
a bridge for transferring data between the first and second transceivers,
wherein at least one of the relay nodes is configured to form a connection to an upstream server via a gateway to another area network,
wherein at least one of the relay nodes is configured to form the connection to the upstream server via the respective first transceiver of one other relay node, such that only a single path at a time along a chain of connections is established upstream, and
wherein each relay node is configured to transfer the data to and from the upstream server via the chain of connections.

2. (canceled)

3. The local area network according to claim 1, wherein the first transceiver and the second transceiver are implemented as logical/virtual independent transceivers by a single physical transceiver.

4. (canceled)

5. The local area network according to claim 1, wherein each relay node in communication with one of the mobile devices is configured to transfer a data file from the respective device to the upstream server via the single path of the chain of connections, and wherein each relay node comprises a storage for storing the data file until it is received by the next node up in the chain of connections to the upstream server.

6-7. (canceled)

8. The local area network according to claim 1, wherein each relay node is configured to receive a message/data from the upstream server and the respective relay node is configured to use the message/data when it is addressed to the respective relay node to control the establishment of the chain of connections/configure the respective relay node.

9-11. (canceled)

12. A local area network comprising a plurality of relay nodes, each relay node comprising:
a transceiver for communicating with one or more other relay nodes, and for communicating with one or more mobile devices,
wherein at least one of the relay nodes is configured to form a connection to an upstream server via a gateway to another area network,
wherein at least one of the relay nodes is configured to form a connection to the upstream server via the respective transceiver of one other relay node, such that a single path along a chain of connections is established upstream,
wherein each relay node is configured to transfer a data file from one or more of the mobile devices to the upstream server via the chain of connections, and
wherein each relay node comprises a storage for storing the data file until it is received by the next node up in the chain of connections.

13. The local area network according to claim 12, wherein the relay node comprises a processor for determining a location of a respective mobile device based on a signal transmitted between the respective mobile device and the transceiver.

14. The local area network according to claim 12, wherein each relay node is configured to determine a signal strength to each of the one or more other relay nodes it communicates with and to report the or each signal strength to the server.

15. A data network comprising:
a gateway for connection to an external network, and
a plurality of spatially separated relay nodes capable of wirelessly communicating with at least two other relay nodes, the gateway and a mobile device,
wherein the gateway is configured to connect to one or more downstream relay nodes, each relay node is configured to connect to only one upstream device comprising one of the gateway and another relay node, and each relay node is configured to connect to one or more downstream relay nodes and/or one or more downstream mobile devices,
wherein relay nodes are configured to establish a single path of a chain of connections upstream to the gateway, such that data is transmitted between the gateway and each mobile device only through relay nodes along the single path that connects the gateway to the mobile device while said chain of connections between the gateway and the mobile device is in place, and
wherein each relay node is configured to receive a message/data from the gateway and the respective relay node is configured to use the message/data when it is addressed to the respective relay node to control the establishment of the chain of connections/configure the respective relay node.

16. The data network according to claim 15, wherein each relay node is configured such that the connection is in place while a data connection requirement between relay nodes is met.

17. The data network according to claim 16, wherein when another relay node of equal or fewer hops to the gateway has a stronger signal strength, the data connection requirement is no longer met and the relay node is configured to connect to the relay node of stronger signal strength so as to reform a new single path along a new chain of connections upstream to the server.

18. The data network according to claim 15, wherein each relay node is configured such that in the event that one or more of the connections between relay nodes does not meet the data connection requirement then each connection between nodes that does not meet the data connection requirement is severed and then sequentially, each relay node that severed the connection seeks to make a chain of connections sequentially back to the gateway.

19. The data network according to claim 15, wherein each relay node is configured such that the establishment of a connection seeks to have the least number of hops from the gateway to the unconnected relay node via other relay nodes.

20. The data network according to claim 15, wherein the relay nodes are configured to connect a path from the gateway to each mobile device by the shortest path by number of hops between relay nodes where the connection between relay nodes meets the data connection requirement.

21. The data network according to claim 15, wherein each relay node comprises a storage for storing a received data file until the file is successfully transmitted to the either the server or the next upstream relay node, or to the gateway, in the upstream direction, or the next downstream relay node or to each mobile device connected to the relay node, in the downstream direction.

22. A network comprising:
a gateway node connectable to another network and connectable to one or more relay nodes,
wherein each relay node is connectable to one or more end point network enabled devices, only one relay node at a time in the upstream direction to the gateway node and one or more other ones of the relay nodes downstream from the gateway node, and each end point network enable device only connects to one relay node at a time,
wherein each relay node is configured to connect to the gateway node via a single path chain of connections of other relay nodes to the gateway node, where the next upstream connection is made to the relay node with the best signal quality, and
wherein each relay node is configured upon being disconnected from a path to the gateway node to attempt to connect to one of the other relay nodes to re-establish a connection to one of i) the gateway node and ii) via the chain of connections.

23. The network according to claim 22, wherein each relay node is configured to buffer a transmitted data file such that in the case of a connection to the gateway or the chain of connections is broken the data file is able to be later transmitted once the connection to the gateway or chain of connections is re-established.

24. (canceled)

25. A location determining system comprising:
a server;
a gateway device for connection to the server; and
a connection based network of spaced apart point relay nodes at known locations, each relay node able to obtain a measurement being an estimate of a location of a mobile device relative to itself and to send the measurement via the gateway to the server,
wherein the server stores valid locations or areas of the mobile device within a defined environment, and
wherein the server is configured to receive measurements and determine an estimated location over time of the or each mobile device based on one or more measurements related to the mobile device, the stored valid locations/areas, and locations of each of the relay nodes.

26. The system according to claim 25, wherein the server determines the estimated location using a particle filtering algorithm.

27. The system according to claim 25, wherein the server stores line of sight areas of each relay node and when determining an estimated location discards possible locations from relay nodes that are not in the stored line of sight near of the respective relay node.

28. The system according to claim 25, wherein possible locations that are inconsistent with the topology of the defined environment are discarded.

29. The system according to claim 25, wherein the measurements are sent to the gateway through one or more of the relay nodes, wherein each relay node stores the measurement in case of a disconnection and is able to send the measurement when reconnected.

30. The system according to claim 25, wherein during a time in which a relay node is unable to receive measurements from the mobile device, the last known location, momentum of the mobile device and the stored valid locations/areas are used to predict the location of the mobile device until measurements from the mobile device are received again.

31. A method of connecting mobile devices to a local area network comprising a plurality of relay nodes, the method comprising:
transmitting a signal between a mobile device and a second transceiver of one of the relay nodes;
determining location information based on the transmitted signal;
transferring the determined location information from the second transceiver to a first transceiver of the respective relay node;
communicating the location information or data in a file with one or more other relay nodes over a chain of connections between the respective relay node and one or more of the other relay nodes to an upstream server; and
storing the file in each relay node until it is received by the next node up in the chain of connections.

32. A method of providing a local area network comprising a plurality of relay nodes, the method comprising:
transmitting a signal between a mobile device and a transceiver of one of the relay nodes;
determining location information based on the signal;
forming a connection to at least one of the relay nodes, which forms a connection to an upstream server via a gateway to another area network; and
receiving a message from the gateway at a relay node,
wherein the connection is formed along a single path at a time along a chain of connection based on configuration data in the message, and
wherein each relay node transfers the location information to the upstream server via the chain of connections.

33. The method according to claim 32, wherein a transceiver of each relay mode operates as a Peripheral when communicating across a connection to a downstream relay node and the transceiver operates as a Central when communicating across a connection to an upstream relay node.

34. (canceled)

35. A method of communication across a data network comprising a gateway for connection to an external network and a plurality of spatially separated relay nodes capable of wirelessly communicating with at least two other relay nodes, the gateway, and a mobile device, the method comprising:
connecting the gateway to one or more first hop relay nodes downstream of the gateway, each first hop relay node broadcasting availability to connect;
connecting a downstream relay node to only one first hop node in response to the broadcast of availability to connect, the connection being to the first hop node with the best signal quality; and
connecting a mobile device to a downstream relay node or to one or more further downstream relay nodes; wherein data is transmitted between the mobile device and the gateway only through relay nodes along a single path that connects the mobile device to the gateway while each connection between the gateway and the mobile device is in place.

36. A network node connection method comprising:
connecting a gateway connectable to another network to one or more relay nodes; and
connecting each relay node to one or more end point network enabled mobile devices or one or more other relay nodes, with only one relay node at a time in the upstream direction to the gateway node and one or more other ones of the relay nodes downstream from the gateway node, and each end point network enable device only connects to one relay node at a time,
wherein the connection of each relay node to the gateway node is via the least number of other relay nodes, and
wherein when a relay node is disconnected from a path to the gateway node the relay node attempts to connect to one of the other relay nodes to establish a connection to the gateway node or to one of the relay nodes connected to the gateway node that has the best signal quality.

37. A method of determining a location comprising:
storing in a server valid locations or areas of a mobile device within a defined environment;
connecting a gateway to the server;
connecting a connection based network of spaced apart point relay nodes at known locations to the gateway;
obtaining a measurement being an estimate of a location of a mobile device relative to itself at one or more of the relay nodes;
sending the measurement via the connection based network to the gateway and then to the server; and
receiving one or more measurements at the server and determining an estimated location of the mobile device based on one or more measurements, locations of the or each of the relay nodes, and the valid locations or areas.

38-45. (canceled)

46. The local area network according to claim 1, wherein each relay node is configured to send signal measurements of a respective mobile device based on a signal transmitted between the respective mobile device and the second transceiver to the upstream server so that the server can determine the location of the mobile device with respect to the respective relay node.

47. The local area network according to claim 1, wherein when the message/data is for a destination that is another mobile device connected to one of the other relay nodes the message/data is sent from the other mobile device to the relay node that is, or is connected to, the destination through the chain of connection established from the destination relay node or the relay node connected to the destination mobile device.

48. The local area network according to claim 14, wherein each relay node receives a command from the server identifying which other relay nodes will form a downstream part of each single path of the chain of connections.

49. The network according to claim 22, further comprising each relay node checking a signal quality to the next upstream relay node in the chain of connections from time to time and when there is a better signal quality to another upstream relay node with equal or fewer connections to the gateway node terminating the current connection to the next upstream relay node in the chain of connections and connecting to the upstream relay node with the better signal strength to establish a new single path chain of connections to the gateway node.

50. The network according to claim 22, wherein the relay nodes are each configured to terminate a connection to another one of the relay nodes when a data connection requirement between relay nodes is not met, or when a data disconnection requirement between relay nodes is met.

51. The network according to claim 22, wherein the relay nodes are each configured to receive a control message from a server addressed to that relay node, via the gateway node and any intervening relay nodes, to control the chain of connections used to connect to the gateway node or to configure the respective relay node.

52. The location determining system according to claim 26, wherein the particle filtering algorithm uses the measurements from only one relay node and historic determined locations and/or other determined attributes of the mobile device, such as movement direction and/or speed.

53. The method according to claim 32, wherein the connection remains in place while a data connection requirement between relay nodes is met, and when the data connection requirement is no longer met, a connection is reestablished from one relay node to another of equal or fewer hops to the gateway according to the best signal strength so as to reform a new single path along a new chain of connections upstream to the server.
